(19) United States
(12) Patent Application Publication
(10) Pub. No.: US 2013/0010120 A1
(43) Pub. Date: Jan. 10, 2013

(54) Door Security System and Method

(76) Inventor: Onyekwelu Nnoruka, Plano, TX (US)

(21) Appl. No.: 13/363,800

(22) Filed: Feb. 1, 2012

Related U.S. Application Data
(60) Provisional application No. 61/571,906, filed on Jul. 7, 2011.

(51) Int. Cl. H04N 7/18

(52) U.S. Cl. 348/155; 348/E07.085

(57) ABSTRACT

A door security system for use with a residential door having a lock according to the present invention includes a keyless entry device configured to attach to a door in electrical communication with the door lock. The system includes a monitoring unit having a motion sensor, a camera, an audio device (e.g. a doorbell) and a processor in data communication with the motion sensor, camera, and keyless entry device. The system includes programming that when executed by the processor causes the processor to activate the camera when the motion sensor detects motion or when the audio unit (e.g. a doorbell) is activated. The system includes programming that causes the processor to selectively activate the keyless entry device to unlock the door lock.

### REFERENCE TO RELATED APPLICATIONS

This application claims the benefit of U.S. Provisional Application Ser. No. 61/571,906, filed on Jul. 7, 2011, titled The SmartBell Detector.

### BACKGROUND OF THE INVENTION

This invention relates generally to security systems and, more particularly, to a door security system for use on a residential door to visually monitor activity adjacent the door and to selectively unlock the door.

Residents of a house or apartment have a desire to know when a person is at the front—whether the visitor is a friend, delivery person, or even a burglar. Sometimes a resident may be home when a visitor rings the doorbell but is at the rear of the house, in the basement, or otherwise unable to conveniently investigate the identity of the visitor. In addition, an elderly or disabled person may have difficulty getting to the door before the visitor leaves. In other instances, the resident of a dwelling may be at work or on vacation and unable to answer the door when a visitor is present. This is especially problematic in that the visitor may be a burglar who breaks into the home after determining no one is home. In such a case, there is no visual record of the intrusion unless a security camera was present and properly positioned.

Various devices and security systems have been proposed for visually recording an entrance area of a business, especially retail entryways. Although assumably effective for their intended purposes, the existing systems and proposals are not configured to collect visual data when motion proximate a door is indicated and when a doorbell is activated. In addition, the existing security systems do not enable residents present at the residence as well as residents away from the residence to be notified with visual data and to respond with instructions on how to respond. Further, the existing security systems do not provide keyless entry in case a resident accidentally leaves his keys in the house.

Therefore, it would be desirable to have a door security system that remedies the limitations of the existing devices and proposals.

### SUMMARY OF THE INVENTION

A door security system for use with a residential door having a lock according to the present invention includes a keyless entry device configured to attach to a door in electrical communication with the door lock. The system includes a monitoring unit having a motion sensor, a camera, an audio device (e.g. a doorbell) and a processor in data communication with the motion sensor, camera, and keyless entry device. The system includes programming that when executed by the processor causes the processor to activate the camera when the motion sensor detects motion or when the audio unit (e.g. a doorbell) is activated. The system includes programming that causes the processor to selectively activate the keyless entry device to unlock the door lock.

Therefore, a general object of this invention is to provide a door security method and system for collecting visual data in the area of a door when motion is detected or when a doorbell is actuated.

Another object of this invention is to provide a door security method and system, as aforesaid, having a monitoring unit that appears to be a traditional doorbell attached to a residential door that collects visual data that may be communicated to electronic devices inside or remote from the monitoring device.

Still another object of this invention is to provide a door security method and system, as aforesaid, having a keyless entry device in electrical communication with a door lock that is configured to unlock the door lock when activated, such as upon receiving a predetermined signal or entry of a code into a keypad.

Yet another object of this invention is to provide a door security method and system, as aforesaid, that includes delivering camera data to electronic devices being monitored by a resident and that enables the resident to determine what actions, if any, should be taken.

A further object of this invention is to provide a door security method and system, as aforesaid, that stores data recorded by said camera into memory for later review by a resident or the police.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a monitoring unit for use by a door security system and method according to a preferred embodiment of the present invention;

FIG. 2 is a perspective view of a keyless entry device for use by the door security system and method according to a preferred embodiment of the present invention;

FIG. 3 is a block diagram illustrating the electronic components of the present invention; and

FIG. 4 is a flowchart illustrating the method and logic of the present invention.

### DESCRIPTION OF THE PREFERRED EMBODIMENT

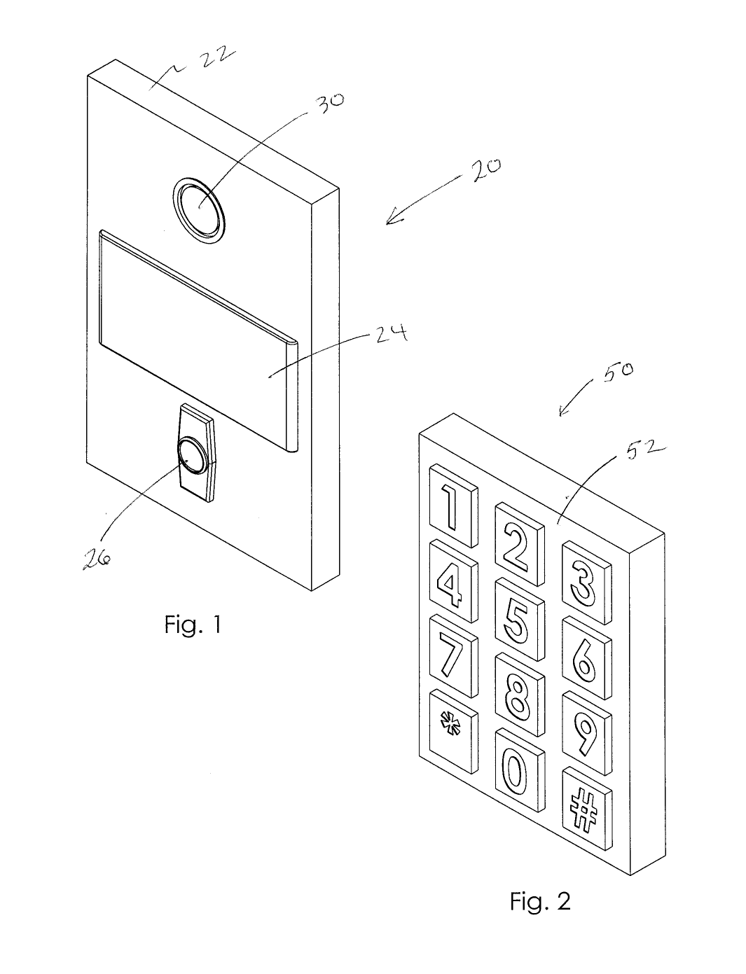

A door security system according to a preferred embodiment of the present invention will now be described with reference to FIGS. 1 to 4 of the accompanying drawings. The door security system 10 may include a monitoring unit 20, a keyless entry device, a processor 40, and a memory 42 having programming.

The monitoring unit 20 may include a housing 22 configured to be attached to a door (not shown) with fasteners such as screws, adhesive, or the like. The monitoring unit 20 may include a motion sensor 24 situated on the front of the housing 22 and configured to monitor motion in front of or below the housing 22. For example, the motion sensor 24 may be automatically activated when a person moves into proximity of the monitoring unit 20, according to programming executed by the processor 40 as will be discussed in further detail later.

The camera 30 may be situated inside the housing 22 and include a wide angle lens positioned on the front of the monitoring unit 20. It is understood that the camera 30 may be a video camera capable of collecting running digital video for a predetermined amount of time or so long as motion is detected by the motion sensor 24. In addition or alternatively, the camera 30 may be configured to take digital still photographs.

The motion sensor 24 and camera 30 are each electrically connected to and in digital communication with the processor 40, the processor 40 being situated inside the housing 22. The memory 42 is also situated inside the housing 22 and in data communication with the processor 40. The memory 42 includes programming capable of controlling the processor 40 and also capable of storing digital video or photography collected by the camera 30.

The audible device 26 may also be situated in the housing 22 and extend through a front thereof where it may be actuated manually be a user. The audible device 26 is configured to emit an audible tone when actuated. More particularly, the audible device 26 may be a traditional doorbell that is also electrically connected to the processor 40 such that its function is determined by programming.

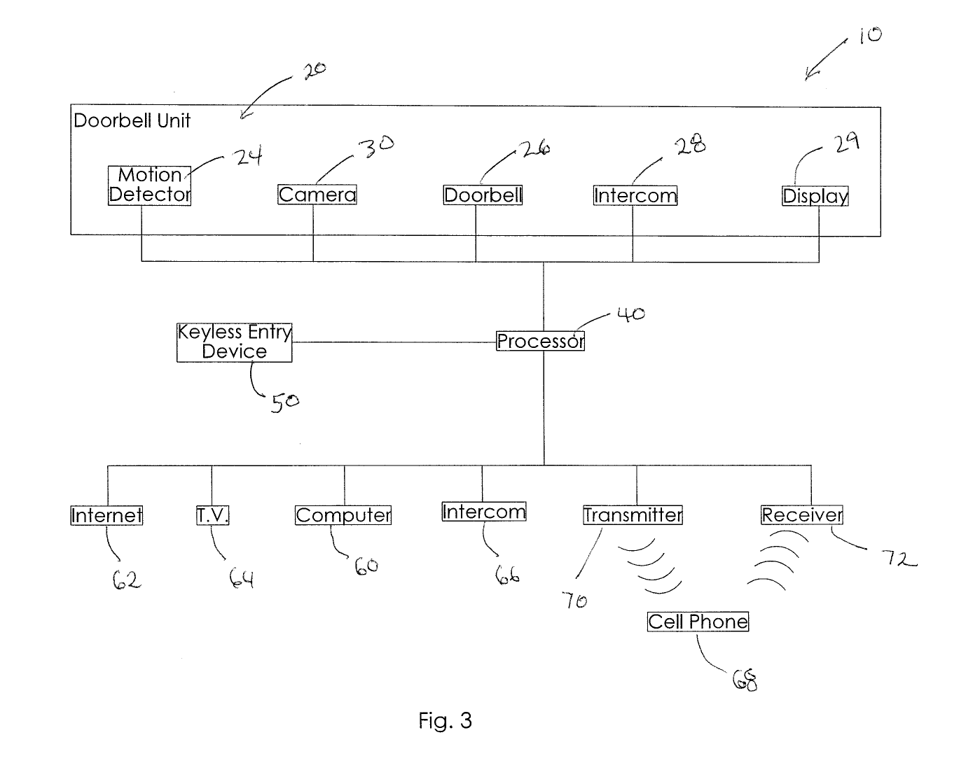

In some embodiments (FIG. 3), the monitoring unit 20 may also include an intercom 28 (different from an intercom 66 discussed later). The intercom 28 on the monitoring unit 20 is configured to receive audible input from a visitor and/or enable a resident in the house to communicate with the visitor. In some embodiments (FIG. 3), the monitoring unit 20 may include a display 29 which may be configured to include a message from the home's resident(s) to a visitor.

In one embodiment, the keyless entry device 50 may be situated inside the housing 22 and electrically connected to the door lock (not shown) of a door (not shown) when the housing 22 is attached to the door as described above. The keyless entry device 50 is configured to unlock the door lock when activated. For example, the keyless entry device 50 may include a solenoid that engages or disengages a door assembly when energized. The keyless entry device 50 may include a cellular signal receiver (not shown) such that the keyless door entry device 50 is actuated when a predetermined cellular signal is received. In another embodiment (FIG. 2), the keyless entry device 50 may include a keypad 52 separate from the monitoring unit 20 and configured to automatically unlock the door lock when a predetermined cellular signal is received.

The door security system 10 may include various electronic devices configured to receive visual data collected by the camera 30. More particularly, the door security system 10 may include an interface, such as a wireless transmitter (not shown) configured to communicate digital data from memory 42 to a computer 60 connected to the internet 62, to a television set 64 inside the residence, to an intercom 66, or to a cellular telephone 68. With regard to the cellular telephone 68, it is understood that in one embodiment data may be transmitted from memory 42 to a nearby cellular transmission device for further transmission to one or more remote cell phones, such as by a transmitter 70 (FIG. 3). In another embodiment, the interface may be configured to immediately transmit data from the camera 30 to a predetermined remote cellular telephone. As will be further discussed later, transmission of camera data to a television 64 or intercom 66 enables a resident who is at the residence to view pictures of a visitor without first moving to the front door. Transmission of camera data to a cellular telephone 68 or to a computer 60 connected to the internet 62 enables a resident not physically at the residence to be notified of a visitor's presence.

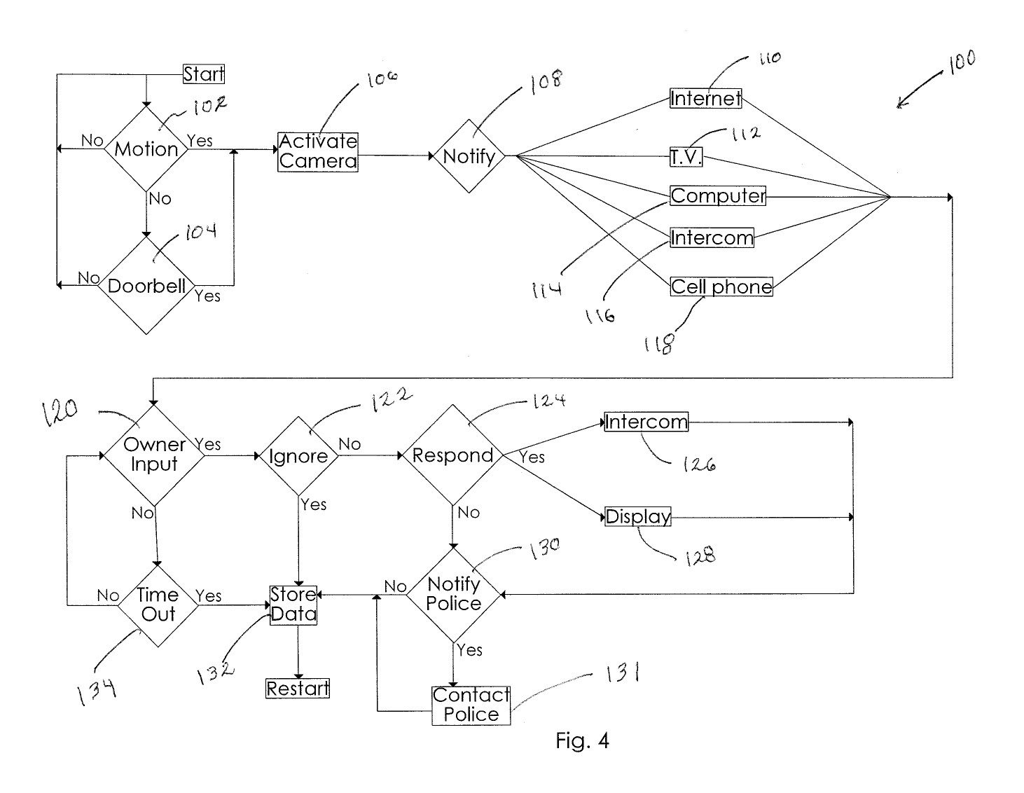

An exemplary method or process 100 of securing a door having a door lock is best understood with reference to FIG. 4. in view of the block diagram of FIG. 3 of the accompanying drawings. At step 102, the processor 40, executing programming, determines if motion has been detected by the motion sensor 24 and, if so, the process 100 proceeds to step 106. Otherwise, the process 100 proceeds to step 104. At step 104, the processor 40 determines if the audio device 26 (also referred to as a doorbell) has been actuated, such as by a visitor pressing a doorbell input button. If the doorbell 26 has been actuated, then the process 100 proceeds to step 106. Otherwise, the process 100 returns to step 102 and again checks to see if motion has been detected.

At step 106, the processor 40 activates the camera 30 to collect visual data, such as video or still photographs. The process 100 then continues to step 108. At step 108, the processor 100, under programming control, determines if one or more electronic devices should be notified and, subsequently, initiates a transmission. It is understood that which electronic devices should be notified may be predetermined in the programming or may be a parameter selected by a user. In FIG. 4, camera data may be delivered to a computer 114 (such as for display on a local computer display inside the residence), to a computer 60 for forwarding to a residence over the internet 110, to a television 112 inside the residence, to an intercom 66 inside the residence 116, or to a cell phone 118 for transmission to a remote resident.

After camera data has been transmitted to a resident, the process 100 continues to step 120. At step 120, the processor 40 determines if a resident/user has responded with a “return” communication. The system, therefore, includes means for receiving a return communication from a resident who previously was notified. The means for receiving a return communication may be in a responsive e-mail to the computer 60 over the internet 62, by a reply to a cell phone transmission, to a receiver 72 or the like. Once a return communication is received, the processor 40, under programming control, may determine an appropriate action at step 120. If a return communication has been received, then the process 100 continues to step 122; otherwise, the process 100 proceeds to step 134. At step 122, the processor 40 determines if the return communication indicates that the camera data is to be ignored and, if so, the process proceeds to step 132. Otherwise, the process 100 proceeds to step 124.

At step 124, the processor 40 determines if the return communication indicates that a response to the camera data should be made, then the processor 40, according to programming, initiates a response either to the intercom at step 126, a computer display at step 128, both, or another predetermined output device. For instance, the resident may direct that a prerecorded message be emitted from the intercom so as to alert a burglar that has been discovered.

After a response has been initiated, the process 100 proceeds to step 130. At step 130, the processor 40 determines if the police should be notified and, if so, proceeds to step 131. Otherwise, the process 100 proceeds to step 132. At step 131, a police or other security organization is notified, such as by e-mail, telephone, or the like. At step 132, the camera data and the return response data may be stored to memory 42 for later reference. For instance, a picture of a burglar may be stored in memory for later transmission to the police. Following storage of camera and other data, the process 100 may be restarted to once again monitor for motion at step 102. At step 134, the processor 40 determines if a return communication has not been received after a predetermined time. If that predetermined time has been exceeded, the process 100 proceeds to step 132 and the camera data is stored in memory 42 without any other action.

In use, if a person presses the doorbell 26 or if the motion sensor 24 detects movement, the camera 30 is activated to collect visual data. The visual data is delivered to predetermined electronic devices so that a user present at the residence may determine who is at the door without physically walking to the door. Residents who are away from the residence may also be notified as described above. The resident, whether home or away, may respond with instructions to the processor 40 regarding what, if any, response should be taken. The system 10 also enables a resident who has locked the door but forgotten his keys to enter the home by actuating the keyless entry device 50, either by cellular signal or keypad.

It is understood that while certain forms of this invention have been illustrated and described, it is not limited thereto except insofar as such limitations are included in the following claims and allowable functional equivalents thereof.

1. A door security system for use with a door having a lock, said door security system comprising:
a keyless entry device configured to attach to the door and in electronic communication with the door lock, the keyless entry device configured to unlock the door lock when actuated;
a monitoring unit including:
a motion sensor configured to detect motion proximate the door when activated;
a camera configured to collect visual data when activated;
an audio device configured to emit an audible alert when actuated;
a processor in data communication with said motion sensor, said camera, said keyless entry device, and said audio device;
memory in data communication with said processor having programming stored therein;
programming in said memory that when executed by said processor causes said processor to activate said camera when said motion sensor detects motion proximate said door;
programming in said memory that when executed by said processor causes said processor to activate said camera when said audio device is activated;
programming in said memory that when executed by said processor causes said processor to selectively activate said keyless entry device to unlock the door lock.

2. The door security system as in claim 1, further comprising:
an interface configured to enable data communication from said processor to one of a television or an intercom device; and
programming in said memory that when executed by said processor causes said processor to deliver data from said camera to said one of said television or said intercom device when said camera has been activated.

3. The door security system as in claim 2, wherein:
said interface is configured to enable data communication from said processor to one of a computer having an internet connection and a cellular telephone;
said door security system further comprising:
programming in said memory that when executed by said processor causes said processor to deliver data from said camera to said one of said computer and said cellular telephone; and
programming in said memory that when executed by said processor causes said processor to activate said one of said computer and said cellular telephone to initiate an outbound communication to a resident after receiving said delivered data from said camera, whereby the resident is notified of said delivered data.

4. The door security system as in claim 3, further comprising:
means in said one of said computer and said cellular telephone for receiving a return communication indicative of a desired response to said delivered data from said camera;
programming in said memory that when executed by said processor causes said processor to store said delivered data in said memory if said return communication is indicative of ignoring said delivered data from said camera;
programming in said memory that when executed by said processor causes said processor to activate said one of a computer and said cellular telephone to initiate an outbound communication to a police or security authority if said return communication is indicative of contacting said police or security authority.

5. The door security system as in claim 4, further comprising programming in said memory that when executed by said processor causes said processor to store said delivered data in memory if no return communication is received within a predetermined time.

6. The door security system as in claim 1, wherein said keyless door entry device is a keypad.

7. The door security system as in claim 1, wherein said keyless door entry device is a cellular signal receiver such that said keyless door entry device is activated to unlock the door lock when a predetermined cellular signal is received.

8. The door security system as in claim 1, wherein said camera is a video camera.

9. The door security system as in claim 4, further comprising programming in said memory that when executed by said processor causes said processor to activate said one of said computer and said cellular telephone to initiate an outbound communication to a resident including said data stored in memory if said return communication is indicative of a request to review all stored data.

10. A method for security for a door having a door lock comprising the steps of:
providing a keyless entry device configured to attach to the door and that is in electronic communication with the door lock, the keyless entry device configured to unlock the door lock when actuated;
providing a monitoring unit configured to attach to the door that includes:
a motion sensor configured to detect motion proximate the door;
a camera configured to obtain visual data proximate the door;
an audio device configured to emit an audible alert when actuated;
activating said camera when said motion sensor detects motion proximate the door;
activating said camera when said audio device is activated; and
selectively activating said keyless entry device to unlock the door lock.

11. The method as in claim 10, further comprising the steps of delivering data from said camera to one of a television and an intercom device when said camera has been activated.

12. The method as in claim 11, further comprising the steps of:
delivering data from said camera to said one of said computer and said cellular telephone; and
activating said one of a computer and said cellular telephone to initiate an outbound communication to a resident after receiving said delivered data from said camera, whereby a resident is notified of said delivered data.

13. The method as in claim 12, further comprising the steps of:
receiving a return communication indicative of a desired response to said delivered data from said camera;
storing said delivered data in memory if said return communication is indicative to “ignore” said delivered data from said camera; and
activating said one of a computer and said cellular telephone to initiate an outbound communication a police or security authority if said return communication is indicative of contacting said police or security authority.

14. The method as in claim 12, further comprising the step of storing said delivered data in memory if no return communication is received within a predetermined time.

15. The method as in claim 13, further comprising activating said one of a computer and said cellular telephone to initiate an outbound communication to a resident including said data stored in memory if said return communication is indicative of a request to review all stored data.
